(19) United States
(12) Patent Application Publication
(10) Pub. No.: US 2016/0353329 A1
(43) Pub. Date: Dec. 1, 2016

(54) DYNAMIC CCA FOR INCREASING SYSTEM THROUGHPUT OF A WLAN NETWORK

(71) Applicant: QUALCOMM TECHNOLOGIES INTERNATIONAL, LTD., Cambridge (GB)

(72) Inventor: Naveen Kumar KAKANI, Coppell, TX (US)

(21) Appl. No.: 14/721,521

(22) Filed: May 26, 2015

(51) Int. Cl. H04W 28/22; H04W 24/10; H04W 40/24; H04W 24/08; H04W 72/04

(52) U.S. Cl. CPC H04W 28/22; H04W 24/08; H04W 72/0446; H04W 40/244; H04W 24/10; H04W 84/12

(57) ABSTRACT

The present invention relates generally to wireless networking, and more particularly to methods and apparatuses for providing increased system throughput of next generation WLAN devices without impacting the throughput of legacy devices. According to certain aspects of the invention, some embodiments allow a controller to set the energy level for an STA to use to determine whether the medium is busy or not. According to certain other aspects of the invention, some embodiments allow an STA to set the energy level individually of the controller but considering the received energy levels from neighbor AP's in the network. According to further other aspects of the invention, some embodiments allow an STA to set the energy level individually by taking into consideration of the load and percentage of legacy devices in the BSS and OBSSs of the network.

### FIELD OF THE INVENTION

The present invention relates generally to wireless networking, and more particularly to methods and apparatuses for increasing system throughput in a WLAN network with next generation WLAN devices without adversely impacting the throughput of the legacy devices in the same WLAN.

### BACKGROUND OF THE INVENTION

Currently, IEEE 802.11 or WFA devices are allowed to access the medium by performing carrier sense multiple access with collision avoidance (CSMA/CA). This requires devices to sense the communication medium to determine if the medium is busy (not available for use) or not (available for use). The status of the medium will be set to busy if the received energy level is equal to or greater than the minimum modulation and coding rate sensitivity, for example, −82 dBm for 20 MHz channel spacing; or if there is any signal on the medium with a received energy level that is 20 dB above the minimum modulation and coding rate sensitivity. Using the same example, for 20 MHz channel spacing, 20 dB above the minimum modulation and coding rate sensitivity resulting in −62 dBm.

To improve the system capacity and throughput, it is proposed in IEEE 802.11-14/0635r1, IEEE 802.11-14/0082r0 and IEEE 802.11-14/0872r0 to increase the thresholds of the energy levels (CCA Level) used to detect whether the medium is busy.

For example, IEEE 802.11-14/0082r0 proposes the following operation according to the concept of BSS color introduced in 11ah: each BSS has a different color by setting some bits in the SIG field of a PPDU or a Beacon frame. As such, an STA knows (with high probability) whether the transmission is within their BSS or not after decoding the SIG field. Transmissions within the BSS are deferred to at the lowest possible level in order to both provide the lowest sensitivity and prevent intra-BSS multiple unsynchronized transmissions (which are bound to be unsuccessful). Transmissions that are perceived to belong to an OBSS (different color) are deferred to based on the CCA threshold value (in 11ah three values of CCA levels exist). The proposed increase of the CCA Level would allow a device to transmit more often, which results in increased system capability.

However, this also results in devices in adjacent/neighbor BSS (OBSS) not being able to use the medium if they don't adjust the CCA level accordingly. They will find the medium to be busy more often than it actually is as they will be using a lower value of energy level to determine whether the medium is busy or not. Also, WLAN devices that do not support a dynamic adjustment of the CCA level (Ex: Legacy devices), both in the BSS and in the OBSS will find the medium to be busy and are therefore unfairly disadvantaged.

Accordingly there remains a need in the art for a solution to address the problem above among others.

### SUMMARY OF THE INVENTION

The present invention relates generally to wireless networking, and more particularly to methods and apparatuses for increasing system throughput of a WLAN with next generation WLAN devices without adversely impacting the throughput of the legacy devices in the same WLAN. According to certain aspects, embodiments of the invention include methods and apparatuses that allow a controller to set the energy level for an STA to use to determine if the medium is busy or not. According to certain other aspects, embodiments of the invention include methods and apparatuses that allow the STA to set the energy level independently of the controller (but considering the received Energy Levels from neighbor APs in the environment). According to certain additional aspects, embodiments of the invention include methods and apparatuses that allow an STA to set the energy level individually by taking into consideration of the load and percentage of legacy devices in the BSS and OBSSs of the network.

### BRIEF DESCRIPTION OF THE DRAWINGS

These and other aspects and features of the present invention will become apparent to those with ordinarily skill in the art upon review of the following description of specific embodiments of the invention in conjunction with the accompanying figures, wherein:

FIG. 1 illustrates an example of a WLAN network with a BSS and an OBSS where embodiments of the invention can be applied.

FIG. 2 is a flow chart illustrating various embodiments of the invention.

FIG. 3 is a flow chart illustrating another embodiment of the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention.

Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The basic service set (BSS) provides the basic building-block of an IEEE 802.11 wireless LAN. In infrastructure mode, a single access point (AP) together with all associated stations (STAs) is called a BSS. The access point acts as a master to control the stations within that BSS; the simplest BSS consists of one access point and one station.

Alternatively, under IEEE 802.11, an ad hoc network of client devices without a controlling access point can also be set up, such a network is called an IBSS (independent BSS).

IEEE 802.11 uses Carrier Sense Multiple Access with Collision Avoidance (CSMA/CA) for multiple devices to share a medium. Clear Channel Assessment (CCA) is a protocol for a wireless device in a WLAN to determine if a radio frequency (or medium) is already in use before it starts to transmit data over the same medium.

IEEE 802.11-14/0635r1 proposed a dynamic sensitivity control mechanism to address some of the problems discussed above. Specifically, IEEE 802.11-14/0635r1 recommends setting CCA threshold values based on both RX Sensitivity and RSSI of the Beacon frame from AP (e.g., R dBm), and setting the maximum value of R dBm to a pre-determined value for STAs located very close to AP. However, this approach only improves the throughput of a specific device at the expense of the overall system throughput and fairness.

IEEE 802.11-14/0082r0 proposed another mechanism to address some of the problems discussed above, which uses a lower CCA threshold value for transmissions within the same BSS and a higher CCA threshold value for OBSS transmissions. Results of simulations using IEEE 802.11-14/0082r0 with fixed CCA threshold values have been reported. In the scenario where there is no neighbor BSS and no MAC Channel Access, the system throughput improved by a factor or 2. In some cases i.e., using a specific CCA threshold value, the improvement was close to a factor of 3. In a scenario where there is a neighboring BSS and MAC channel access, the system throughput improvement ranges from 18% to 52%. See IEEE 802.11-14/0861r0.

However, none of the above proposed simulations suggests setting the value dynamically, which can potentially allow the improvement to be at the maximum.

To address the problems discussed above, IEEE 802.11-14/0872r0 proposed a protocol that dynamically adjusts CCA threshold values based on data frame transmissions. Specifically, IEEE 802.11-14/0872r0 suggests that each transmitting wireless device signals to other devices an increase in CCA threshold that other devices should use for a PPDU it is transmitting. However, this approach fundamentally misses out utilizing the frequent transmissions from OBSS, such as the Beacon frames transmitted by an adjacent BSS. Further, this proposed approach depends on the convergence of CCA threshold values. However, converging to a fixed CCA threshold value can take a long time and it depends on the user traffic pattern (measurement made based on transmitted packets). As a result, more likely than not the STAs will end up using the same CCA threshold value as the current one because the threshold value does not converge within a given time period. Even if the value would converge, starting from that value at the start of next transmission time (for the STA) might not be a good starting point as the traffic pattern of the STAs around the STA might not be the same. It is better to start from a value based on the network condition that will be not affecting other STAs around the current STA, but at the same time not disadvantaging the STA itself.

The present invention that addresses the issues discussed above and various other issues will be described below in conjunction with embodiments compatible with standards such as those of the IEEE 802.11. However, the invention is not limited to these embodiments, and the principles of the invention can be extended to applications using other standards or proprietary or other wireless environments that primarily use medium sensing before transmitting on the medium, such as such as Bluetooth, Zigbee.

In an IEEE 802.11 system, RSSI is the relative received signal strength in a wireless environment. RSSI is thus an indication of the power level being received by the antenna. In other words, a higher RSSI number indicates a higher signal energy level. Therefore, RSSI can be used by a wireless device to determine when the amount of signal energy in the medium is below a certain threshold at which point the wireless device can access the medium to send data.

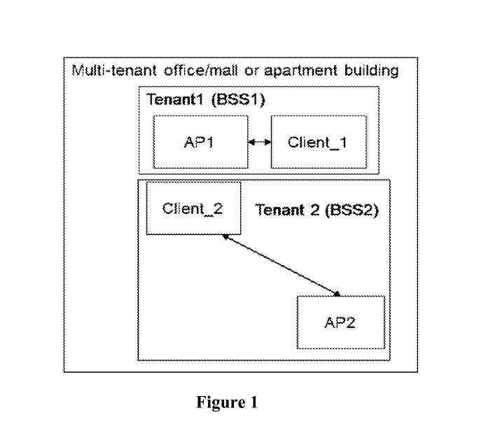

FIG. 1 is a diagram illustrating an exemplary WLAN environment with two BSS systems in which embodiments of the invention can be applied to improve the system throughput of the wireless devices and the BSS systems.

The STAs in this example include an entertainment device like an audio speaker, a video player.

In FIG. 1, a Client can use CCA_th, which denotes the threshold, to determine if medium is busy or not based on legacy implementation.

Client_1, an STA device associated with BSS1, receives a signal from the AP with which it is associated (i.e., AP1) at an energy level higher than the CCA_th. To increase the system throughput, Client_1 uses a threshold (denoted CCA_th_c1) that has a higher value than CCA_th.

Client_2 is an STA device associated with BSS2 and also receives signal from AP₁ with which it is not associated. Client_2 is configured to use a threshold value around the same value as CCA_th. However, because of its proximity with BSS1 that consists of AP1 and Client_1, it receives the signal from AP1 at a higher level than CCA_th. Given that Client_1 is using CCA_th_c1 (where CCA_th_c1>CCA_th) as the threshold for medium occupancy detection, Client_2 will likely not be able to access the medium until both AP₁ and Client_1 have completed transmitting their data or are in backoff mode.

To improve the medium access and system throughput for Client_2 as depicted in FIG. 1, there are a few possible changes that can be implemented in Client_2 based on the RSSI values of the signals Client_2 receives from its own AP₂ and the neighboring AP1. Table 1 lists the possible cases where certain aspects of the invention can be applied.

TABLE 1
Impact of Using Different CCA Threshold for Different RSSI Strengths
Relative to CCA_th

| Case | RSSI from | Neighbor AP | Using CCA Threshold > | Using CCA Threshold = |
|---|---|---|---|---|
| No. | own AP | Beacon RSSI | CCA_th | CCA_th |
| 1 | RSSI = | RSSI > | Improves throughput of | Limits transmission |
| | CCA_th | CCA_th | Client_2 but it can effect | opportunities for Client_2 |
| | | | devices in its BSS | |
| 2 | RSSI > | RSSI = | Improves throughput of | Maintains Legacy Device |
| | CCA_th | CCA_th | Client_2 but can effect | performance |
| | | | devices in its BSS | |
| 3 | RSSI = | RSSI = | Results in Client_2 using | Maintains Fairness |
| | CCA_th | CCA_th | the medium ineffectively | |
| 4 | RSSI > | RSSI > | Improves System Capacity | Will limit medium usages |
| | CCA_th | CCA_th | | of the device |

In Case No. 1 of Table 1, Client_2 receives from AP2 in BSS2 a signal with a RSSI value equal to CCA_th. Client_2 also receives a Beacon signal from a neighboring AP (AP₁) with a RSSI value higher than CCA_th. The throughput of Client_2 can be improved by using a CCA threshold higher than CCA_th. This using of an increased CCA threshold only by Client_2 will however adversely affect the other devices in BSS2—as Client_2 will have advantages in gaining access to the medium over the other STAs in BSS2 that do not adjust their threshold values dynamically. However, is Client_2 uses CCA threshold equal to CCA_th as in a legacy system, as discussed above with respect to FIG. 1, due to its proximity to AP1, Client_2's chance to gain access to the medium for transmission will be limited.

In Case No. 2, Client_2 receives from AP2 in BSS2 a signal with a RSSI value higher than CCA_th, and receives a Beacon signal from AP1 in the neighboring BBS1 with a RSSI value equal or close to CCA_th. The throughput of Client_2 can be improved by using a CCA threshold that is higher than CCA_th, as in Case No. 1. However, if Client_2 uses CCA threshold equal to CCA_th, Client_2 can maintain its legacy performance as the RSSI from neighboring AP1 is of similar strength so Client_2 is not at a disadvantage compared to the STAs in the neighboring BSS1 in gaining access to the medium for transmission.

In Case No. 3, Client_2 receives from AP2 BSS2 a signal with a RSSI value equal or close to CCA_th and receives a Beacon signal from a neighboring AP (AP1) with the RSSI value also equal or close to CCA_th. By using a CCA threshold that is higher than CCA_th in this scenario, however, it leads Client_2 to believe that the medium is always idle thus hog the use of the medium, thus making the use of the medium unfair to the other STAs. If Client_2 uses instead CCA threshold equal to CCA_th, Client_2 and the other STAs in both BSS1 and BSS2 will get their fair share of using the medium.

In Case No. 4, Client_2 receives from its own AP (AP2) in BSS2 a signal with a RSSI value higher than CCA_th and receives a Beacon signal from a neighboring AP (AP1) with the RSSI value also higher than CCA_th. By using a CCA threshold that is higher than CCA_th in this scenario, the throughput of Client_2 improves as it will be more likely to get access to the medium. However, if Client_2 does not increase its CCA threshold value, and keeps using CCA threshold equal to CCA_th, Client_2's access to the medium will be limited because STAs that are using a higher CCA threshold can start accessing the medium earlier than Client_2 and consequently Client_2 will continue to back off.

In summary, as discussed above, if Client_2 uses a CCA threshold value higher than CCA_th, in Case Nos. 1 and 3, other STAs in the BSS or in the adjacent BSS will be adversely affected; in Case No. 2, STAs in adjacent BSS will be adversely affected.

Also as discussed above, if Client_2 uses a CCA threshold that equals CCA_th, Client_2 would suffer adverse impact in Case No. 1 and No. 4.

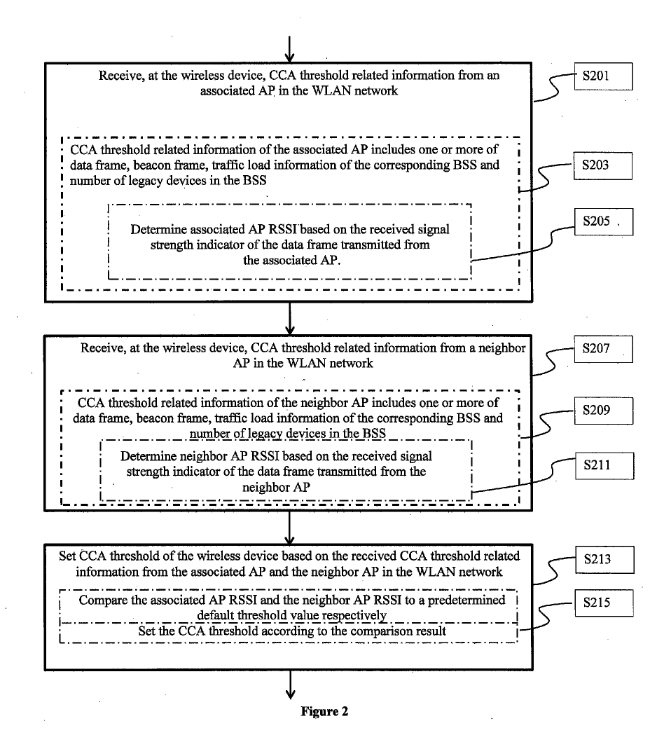

Accordingly, one aspect of the present invention is for Client_2 to use a CCA threshold value higher than CCA_th in Case Nos. 1, 2 and 4, and to use a CCA threshold value equal to CCA_th for Case No. 3. One other aspect of the invention is to use CCA threshold higher than CCA_th for Case Nos. 1 and 2 but with some other conditions as discussed in more details with respect to FIG. 2 below. The invention thus minimizes or eliminates the adverse impact on other STAs in the same BSS or adjacent BSS while improving the throughput of Client_2.

The following discussion focuses on operations according to certain aspects of the invention that address the issue of Client_2 impacting adversely other devices when it is using CCA Threshold value higher than CCA_th.

First, client_2 measures RSSI of Beacon frames from one or more neighbor APs. If the RSSI value of a beacon from a neighbor AP received at Client_2 is above the RSSI value of a beacon frame from its associated AP (AP2), Client_2 includes the RSSI value of that neighbor AP beacon frame into a set denoted as OBSS_Above. After a predetermined time period, Client_2 computes the minimum RSSI values of all the neighbor AP beacon frames in the OBSS_Above set, and saves it as MIN_RSSI. For the same time period, Client_2 also computes the maximum RSSI value of all RSSI of Neighbor AP Beacon frames in the set OBSS_Above and saves it as MAX_RSSI.

Next, Client_2 transmits to its associated AP RSSI information including values such as RSSI from Associated AP, MIN_RSSI and MAX_RSSI, RSSI from Neighbor APs.

After receiving the RSSI information from Client_2, the AP (AP2) with which Client_2 is associated sends signals to the STAs in BSS2 to provide instructions about their respective CCA threshold values. AP2 may send different instructions depending on the composition of the BSS2, as discussed in more details below.

In cases where the number of Associated STAs in the BSS that are legacy devices is lower than a legacy device threshold number, AP2 signals to STAs in BSS2 to set their CCA independently by setting certain Signal bits in the Beacon frame, or signaling this explicitly to the STA in response to STA message to the AP with the RSSI values. If the AP is signaling in the Beacon, there is no need for Client_2 to transmit data to AP.

It should be noted that the legacy device threshold number can be implemented as a programmable feature according to certain embodiments of the invention. For example, the system can program it to be 5% for one implementation and 10% in another implementation. In some embodiments, the system can dynamically change it based on the change in the configuration of the BSS2.

After receiving the CCA signaling from AP, Client_2 then sets its CCA Threshold for its BSS and its CCA threshold for OBSS (i.e., Neighbor BSS) separately. For its BSS, Client_2 sets its CCA threshold following the mechanism as proposed in IEEE 802.11-14/0635r1. For example, Client_2 starts a timer T, then records RSSI of each beacon frame received from the associated AP. For each recorded RSSI, Client_2 compares it to a predetermined upper limit. If a recorded RSSI is larger, Client_2 resets that recorded RSSI to the predetermined upper limit. Client_2 then calculates a moving average or a weighted average (based on number of APs signals that are received in a range of RSSI values) of all the recorded RSSIs recorded over an update period which is effectively determined by the timer T. At the end of each predetermined update period, Client_2 converts the moving average to RX sensitivity.

In some implementations, the RX sensitivity is set to RX threshold which equals the moving average subtracted by a predetermined margin, which margin could be set according to the current IEEE standard.

In some implementations, the RX threshold is checked to make sure that it is not less than a predetermined minimum value. In some implementations, the average RSSI is adjusted and the RX threshold is instantly reset when Client_2 missed a beacon or consecutive beacons.

For OBSS, Client_2 may set its CCA Threshold according to equation (1). Alternatively, Client_2 may set its CCA Threshold according to equation (2).

CCA Threshold=Average of MIN_RSSI and MAX_RSSI−Margin (1)

CCA Threshold=Average of RSSI of all Neighbor APs in the set OBSS_Above−Margin (2)

where the Margin in above equations is typically set according to the IEEE standard or based on the value signaled by the AP.

The Margin value is usually set to 20 dBm. It should be noted however that the Margin value can be set to a value different from the 20 dBm, or it can be a value that AP2 sends to the STAs in a beacon frame.

In scenarios where there are a large number of Legacy STAs in the BSS2, fairness to Legacy Devices is important. In these scenarios, AP2 signals global setting of CCA Threshold to be used by all STAs and sends a specific CCA Threshold value to all STAs by including the CCA Threshold value in a Beacon frame.

It should be noted that there are different ways that AP2 can instruct the STAs to use a global CCA threshold and what that global CCA threshold value should be. The invention described above should work with a WLAN network that contains legacy devices as long as the signaling AP2 uses to communicate these instructions conforms to the relevant IEEE standard.

In scenarios where there is a large variation in the values of MIN_RSSI and MAX_RSSI values measured by the STAs in the BSS2, AP2 signals in the Beacon Frame that it is assigning CCA threshold values individually to each STA. For example, AP2 decides the individual CCA threshold value based on the measurements provided to AP2 by Client_2, and AP2 sends to Client_2 with the CCA threshold value to be used.

In the above discussion, the RSSI from neighbor APs is used, as an example, for computing the value of the CCA threshold to be used by a specific client or even for the global setting of the CCA value. It should be apparent to a person of ordinary skill in the art that other measurements or information reflecting the conditions of the network may also be used in dynamically determining and setting the CCA_th. For example, in addition to the RSSI of beacon frames from neighbor APs, the AP2 may also use any or some combination of the following measurements or information to compute the value of the CCA threshold, either to be used by a specific client device STA or for the global setting of the CCA value:
a. the measurements that AP2 has received from other clients in its BSS besides Client_2;
b. information AP2 might have learned from the measurements that the neighbor BSS is using, including any global setting of the CCA value that they are using;
c. information about the load on the neighbor BSSs, such as the number of legacy devices, traffic load which can be the actual medium usage in the neighbor BSS; or
d. additional data that AP2 might have received from a controller to which the APs are connected.

The various aspects of the invention described above improve throughput not just for a specific device (Client_2) in the BSS2, but for all devices in the BSS2. Under this new scheme, legacy devices can be well protected because the configuration of the CCA threshold values is dependent on a centralized controller that is aware of the number of legacy (802.11a/b/g/n/ac) and non-legacy devices in the network. Also, the centralized controller can possibly have additional information about the APs in the area where the BSS is operating (AP to AP exchange, or getting information from a server in the backend).

FIG. 2 is a flow chart illustrating various embodiments of the invention. In FIG. 2, to set the CCA threshold value for a wireless device in the WLAN network, the wireless device first receives (S201) CCA threshold related information from an AP with which the wireless devices is associated. The CCA threshold related information from an associated AP may include (S203) one or more of data frames transmitted by the associated AP, beacon frames transmitted by the associated AP, traffic load information of the BSS including the associated AP and the number of legacy devices in the BSS. In some embodiments, the wireless device determines (S205) associated AP RSSI based on the received signal strength indicator of the data frames the wireless device receives from the associated AP.

The wireless device also receives (S207) CCa threshold related information from a neighbor AP in the WLAN network. The CCA threshold related information from a neighbor AP may include (S209) one or more of data frames transmitted by the neighbor AP, beacon frames transmitted by the neighbor AP, traffic load information of the BSS including the neighbor AP and the number of legacy devices in that BSS. In some embodiments, the wireless device determines (S211) neighbor AP RSSI based on the received signal strength indicator of the data frames the wireless device receives from the associated AP.

At step S213, the wireless device sets CCA threshold value based on the received CCA threshold related information from the associated AP(s) in the WLAN network and CCA threshold related information from the neighbor AP(s) in the WLAN network. In some embodiments, the wireless device compares the associated AP RSSI and neighbor AP RSSI respectively to a predetermined default threshold value and set the CCA threshold value according to the comparison result. Upon determining that the associated AP RSSI is substantially similar or equal to the predetermined default threshold value and that the neighbor AP RSSI is substantially similar or equal to the predetermined default threshold value, The wireless device sets the CCA threshold to the predetermined default threshold value. If it is determined that at least one of the associated AP RSSI and the neighbor AP RSSI is higher than the default value by a predetermined margin, the wireless device sets the CCA threshold to a value higher than the predetermined default threshold value.

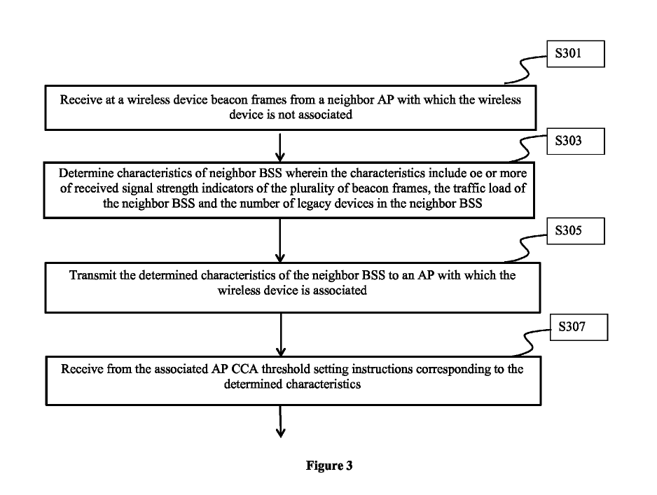

FIG. 3 is a flow chart illustrating another embodiment of the invention. In FIG. 3, to set the CCA threshold value of a wireless device, the wireless device first receives (S301) a plurality of beacon frames from a neighbor AP with which the wireless device is not associated. After receiving the beacon frames, the wireless device determines (S303) the characteristics of the neighbor BSS to which the neighbor AP belongs. These characteristics of the neighbor BSS may include one or more of the received signal strength indicators (RSSI) of the received beacon frames, the traffic load of the neighbor BSS and/or the number of legacy devices the neighbor BSS. The wireless device next transmits (S305) the determined characteristics of the neighbor BSS to an AP with which the wireless device is associated. The wireless devices then receives (S307) CCA threshold setting instructions corresponding to the determined characteristics from the associated AP and sets the CCA threshold values according to the instructions.

In the various embodiments discussed above, the “STA” device is typically any portable device (e.g. iPhone or similar smartphone, iPad or similar tablet computer, smart watch, laptop or notebook computer, etc.) that has built-in WiFi and/or Bluetooth transceiver capabilities such as those provided in chipsets and associated firmware from manufacturers. Those skilled in the art will be able to implement the STA functionality of the invention by adapting such chipsets and/or firmware after being taught by the present examples.

In the various embodiments discussed above, the “AP” device is either a standalone device (e.g. a device similar to a wired Access Point), a peripheral device (e.g. display screen) that has integrated AP functionality, or it can be a device such as a laptop/desktop that can allow an STA to be connected to it either by wired connection or wirelessly (e.g., WiFi Direct).

In some of the embodiments, AP functionality is implemented by chipsets and associated firmware from manufacturers. Those skilled in the art will be able to implement the principles of the invention by adapting such chipsets and/or firmware after being taught by the present examples.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A method for increasing throughput of wireless devices and systems in a WLAN network including legacy wireless devices, comprising:
receiving, at a wireless device in the WLAN, Clear Channel Assessment (CCA) threshold related information from an associated Access Point (AP), wherein the associated AP is an AP with which the wireless device is associated;
receiving, at the wireless device, CCA threshold related information from a neighbor AP, wherein the neighbor AP is an AP with which the wireless is not associated;
setting the CCA threshold of the wireless device based on the received CCA threshold information from both the associated AP and the neighbor AP.

2. The method of claim 1, wherein the CCA threshold related information from an associated AP includes one or more of the group consists of frame data, beacon frame, traffic load information of the Basic Service Set (BSS) corresponding to the associated AP, and number of legacy wireless devices in the BSS corresponding to the associated AP.

3. The method of claim 1, wherein the CCA threshold related information from a neighbor AP includes one or more of the group consists of frame data, beacon frame, traffic load information of the BSS corresponding to the neighbor AP, and number of legacy wireless devices in the BSS corresponding to the neighbor AP.

4. A method for increasing throughput of wireless devices and systems in a WLAN including legacy wireless devices, comprising:
receiving, at a wireless device in the WLAN, a frame transmitted from an associated AP, wherein the associated AP is an AP with which the wireless device is associated;
determining an associated AP RSSI based on the received signal strength indicator (RSSI) of the frame transmitted from the associated AP;
receiving, at the wireless device, a frame transmitted from a neighbor AP, wherein the neighbor AP is an AP with which the wireless is not associated;
determining a neighbor AP RSSI based on the RSSI of the beacon frame from the neighbor AP;
setting the CCA threshold of the wireless device based on the associated AP RSSI and the neighbor AP RSSI.

5. The method of claim 4, wherein the setting the CCA threshold further comprising:
comparing the associated AP RSSI to a predetermined default threshold value;
comparing the neighbor AP RSSI to the predetermined default threshold value;
upon determining that the associated AP RSSI is substantially similar or equal to the predetermined default threshold value and that the neighbor AP RSSI is substantially similar or equal to the predetermined default threshold value, setting the CCA threshold to the predetermined default threshold value; and
upon determining that at least one of the associated AP RSSI and the neighbor AP RSSI is higher than the default value by a predetermined margin, setting the CCA threshold to a value higher than the predetermined default threshold value.

6. The method of claim 5, wherein the setting the CCA threshold further comprising:
determining measurements of the associated AP RSSI and the neighbor AP RSSI;
transmitting from the wireless device the determined measurements to the associated AP;
receiving instructions from the associated AP, wherein the instructions are based on the determined measurements; and
setting the CCA threshold according to the received instructions.

7. The method of claim 6, wherein the determined measurements comprise at least one or more of: RSSI from the associated AP, the minimal value of a plurality of neighbor AP RSSIs, the maximum value of a plurality of neighbor AP RSSIs.

8. The method of claim 6, wherein the determining further comprising:
comparing a neighbor AP RSSI with an associated AP RSSI;
for a predetermined time period, upon determining that a neighbor AP RSSI has a value higher than the corresponding associated AP RSSI, including said neighbor AP RSSI into a set of higher neighbor AP RSSIs;
computing minimum RSSI by calculating the minimum of the set of higher neighbor AP RSSIs; and
computing maximum RSSI by calculating the maximum of the set of higher neighbor AP RSSIs.

9. The method of claim 6, further comprising:
transmitting, from the associated AP, instructions signaling to associated wireless devices to set their CCA threshold value independently.

10. The method of claim 9, further comprising:
setting, at the wireless device, a first CCA threshold for data received from the associated AP and other associated wireless devices in the same BSS; and
setting, at the wireless device, a second CCA threshold for data received from a neighbor BSS.

11. The method of claim 10, wherein the setting first CCA threshold comprising:
calculating RX sensitivity of the wireless device;
upon determining that the RX sensitivity is higher than the predetermined default threshold value, setting the first CCA threshold to the RX sensitivity; and
upon determining that the RX sensitivity is lower than the predetermined default threshold value, setting the first CCA threshold to the predetermined default threshold value.

12. The method of claim 11, wherein the calculating the RX sensitivity comprising:
for each predetermined update period, recording RSSI of each beacon frame from the associated AP;
upon determining the recorded RSSI is higher than a predetermined upper limit, setting that recorded RSSI value to predetermined upper limit;
calculating a moving average of all recorded RSSIs of the update period; and
at the end of each predetermined update period, converting the moving average to RX sensitivity.

13. The method of claim 12, wherein the converting comprising:
setting RX threshold of the wired device equal to the moving average minus a predetermined RX sensitivity margin; and
setting the RX sensitivity to the RX threshold upon determining that the RX threshold is higher or equal to a predetermined lower limit.

14. The method of claim 13, wherein the converting comprising:
adjusting the average RSSI upon determining that the wireless device has missed at least one beacon frame; and
resetting the RX sensitivity.

15. The method of claim 10, wherein the second CCA threshold equals the average of the minimum RSSI and the maximum RSSI subtracted by a predetermined CCA threshold margin.

16. The method of claim 15, wherein the predetermined CCA threshold margin equals 20 dBm.

17. The method of claim 10, wherein the second CCA threshold equals average of all the neighbor AP RSSIs in the set of higher neighbor AP RSSIs subtracted by a predetermined CCA threshold margin.

18. The method of claim 17, wherein the predetermined CCA threshold margin equals 20 dBm.

19. The method of claim 6, wherein the instructions from the associated AP comprising instructions signaling to all associated wireless devices to use a global CCA threshold.

20. The method of claim 19, wherein the global CCA threshold is signaled in a beacon frame of the associated AP.

21. The method of claim 6, wherein the instructions from the associated AP comprising instructions signaling to all associated wireless devices that it is assigning CCA threshold individually to each associated wireless device.

22. The method of claim 21, wherein the individual CCA threshold is determined based on the measurements that the associated AP received from the corresponding associated wireless device.

23. A method for increasing throughput of wireless devices and systems in a WLAN including legacy wireless devices, comprising:
receiving, at a wireless device in the WLAN, a plurality of beacon frames from a neighbor AP with which the wireless device is not associated;
determining, at the wireless device, the characteristics of the neighbor BSS wherein the characteristics of the neighbor BSS include one or more of received signal strength indicators (RSSIs) of the plurality of beacon frames, the traffic load of the neighbor BSS and the number of legacy devices in the neighbor BSS;
transmitting the determined characteristics of the neighbor BSS to an AP with which the wireless device is associated; and
receiving from the AP with which the wireless device is associated CCA threshold setting instructions to the wireless device.

24. A method for increasing throughput of wireless devices and systems in a WLAN including legacy wireless devices, comprising:
receiving, at a wireless device in the WLAN, a plurality of beacon frames from a neighbor AP with which the wireless device is not associated;
determining, at the wireless device, the characteristics of the received signal strength indicators (RSSIs) of the plurality of beacon frames;
transmitting the determined characteristics of the RSSIs to an AP with which the wireless device is associated;
receiving, at the AP with which the wireless device is associated, the determined characteristics; and
transmitting, from the AP with which the wireless device is associated, CCA threshold setting instructions to the wireless device.

25. A WLAN network system including legacy wireless devices having increased throughput comprising:
a wireless device in the WLAN receiving a plurality of beacon frames from a neighbor AP with which the wireless device is not associated, wherein the wireless device is configured to determine the characteristics of the neighbor BSS; and
an AP with which the wireless device is associated, wherein the AP is configured to receive the determined characteristics of the neighbor BSS transmitted by the wireless device, determine CCA threshold setting instructions and transmit the CCA threshold setting instructions to the wireless device.

26. The system of claim 25, wherein the characteristics of the neighbor BSS include one or more of received signal strength indicators (RSSIs) of the plurality of beacon frames, the traffic load of the neighbor BSS and the number of legacy devices in the neighbor BSS.

27. A WLAN network system including legacy wireless devices having increased throughput comprising:
a wireless device in the WLAN;
an associated AP with which the wireless device is associated; and
a neighbor AP with which the wireless device is not associated,
wherein the wireless device is configured to receive CCA threshold related information from the associated AP and the neighbor AP respectively and set the CCA threshold of the wireless device based on the received CCA threshold information from both the associated AP and the neighbor AP.

28. The system of claim 27, wherein the CCA threshold related information from an associated AP includes one or more of the group consists of frame data, beacon frame, traffic load information of the BSS corresponding to the associated AP, and number of legacy wireless devices in the BSS corresponding to the associated AP.

29. The system of claim 27, wherein the CCA threshold related information from a neighbor AP includes one or more of the group consists of frame data, beacon frame, traffic load information of the BSS corresponding to the neighbor AP, and number of legacy wireless devices in the BSS corresponding to the neighbor AP.

30. A WLAN system including legacy wireless devices having increased throughput comprising:
a wireless device;
a neighbor AP with which the wireless device is not associated, wherein the wireless device is configured to receive a plurality of beacon frames from the neighbor AP, determine the characteristics of the received signal strength indicators (RSSIs) of the plurality of beacon frames and transmit to the neighbor AP the determined characteristics; and
an associated AP with which the wireless device is associated, wherein the associated AP is configured to receive the determined characteristics of the RSSIs transmitted by the wireless device, determine CCA threshold setting instructions at least partially based on the received characteristics of the RSSIs transmitted by the wireless device, and transmit the CCA threshold setting instructions to the wireless device.
